(19) United States
(12) Patent Application Publication
(10) Pub. No.: US 2010/0085024 A1
(43) Pub. Date: Apr. 8, 2010

(54) POWER SUPPLY CONTROLLER WITH DIFFERENT STEADY STATE AND TRANSIENT RESPONSE CHARACTERISTICS

(75) Inventors: Michael Jason Houston, Cary, NC (US); Shawn Evans, Raleigh, NC (US)

Correspondence Address: GRAYBEAL JACKSON LLP, 400 - 108TH AVENUE NE, SUITE 700, BELLEVUE, WA, 98004, US

(73) Assignee: INTERSIL AMERICAS INC., Milpitas, CA (US)

(21) Appl. No.: 12/498,287

(22) Filed: Jul. 6, 2009

Related U.S. Application Data
(60) Provisional application No. 61/102,344, filed on Oct. 2, 2008.

(51) Int. Cl. G05F 1/10

(52) U.S. Cl. 323/281

(57) ABSTRACT

An embodiment of a power-supply controller includes a control circuit and a detection circuit. The control circuit has a signal characteristic, and is operable in response to a regulated output signal and a reference signal to cause at least one power-supply phase to generate the regulated output signal. The detection circuit is operable to detect a change in the regulated output signal, and to alter the signal characteristic of the control circuit in response to the detected change.

### CLAIM OF PRIORITY

This application claims priority to U.S. Provisional Application Ser. No. 61/102,344 filed on Oct. 2, 2008, which is incorporated by reference.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

An embodiment of a power-supply controller includes a control circuit and a detection circuit. The control circuit has a signal characteristic, and is operable to generate a regulated output signal. The detection circuit is operable to detect a change in the regulated output signal, and to alter the signal characteristic of the control circuit in response to the detected change.

For example, in an embodiment, such a dual-mode (e.g., steady-state and transient modes) power-supply controller may be part of a switching power supply that provides a regulated output voltage to a load. The detection circuit may detect a transient (e.g., a sudden increase or decrease) in the regulated output voltage due to a transient in the current being drawn by the load, and, in response to the transient in the output voltage, may temporarily increase the bandwidth of the control circuit so that the control circuit can more quickly bring the output voltage back to its regulated value (transient mode). After the temporary increase in the control circuit's bandwidth, the detection circuit allows the bandwidth of the control circuit to return to a lower value. During steady-state operation of the power supply (steady-state mode), this lower bandwidth may allow the control circuit to filter out more noise, and to thus reduce jitter in the switching of the power-supply phase(s), as compared to a control circuit with a higher steady-state bandwidth.

### BRIEF DESCRIPTION OF THE DRAWINGS

FIG. 1 is a schematic diagram of an embodiment of a power supply and of a load to which the supply provides a regulated output signal.

FIG. 2 is a more detailed schematic diagram of an embodiment of the power supply of FIG. 1.

FIG. 3 is a timing diagram that compares a control signal generated by an embodiment of the dual-mode power supply of FIG. 2 during steady-state operation with a control signal generated under similar load conditions by a single-mode power supply.

FIG. 4A is a timing diagram of a phase voltage generated by an embodiment of the power supply of FIG. 2 during steady-state operation.

FIG. 4B is a timing diagram of a phase voltage generated by a single-mode power supply during steady-state operation.

FIG. 5A is a timing diagram that compares a control signal generated by an embodiment of the dual-mode power supply of FIG. 2 during transient operation with a control signal generated under similar load conditions by a single-mode power supply.

FIG. 5B is a timing diagram that compares an output current generated by an embodiment of the dual-mode power supply of FIG. 2 during transient operation with an output current generated under similar load conditions by a single-mode power supply.

FIG. 5C is a timing diagram that compares an output voltage generated by an embodiment of the dual-mode power supply of FIG. 2 during transient operation with an output voltage generated under similar load conditions by a single-mode power supply.

FIG. 6 is a block diagram of an embodiment of a computer system that may incorporate an embodiment of at least one of the power supplies of FIGS. 1 and 2.

### DETAILED DESCRIPTION

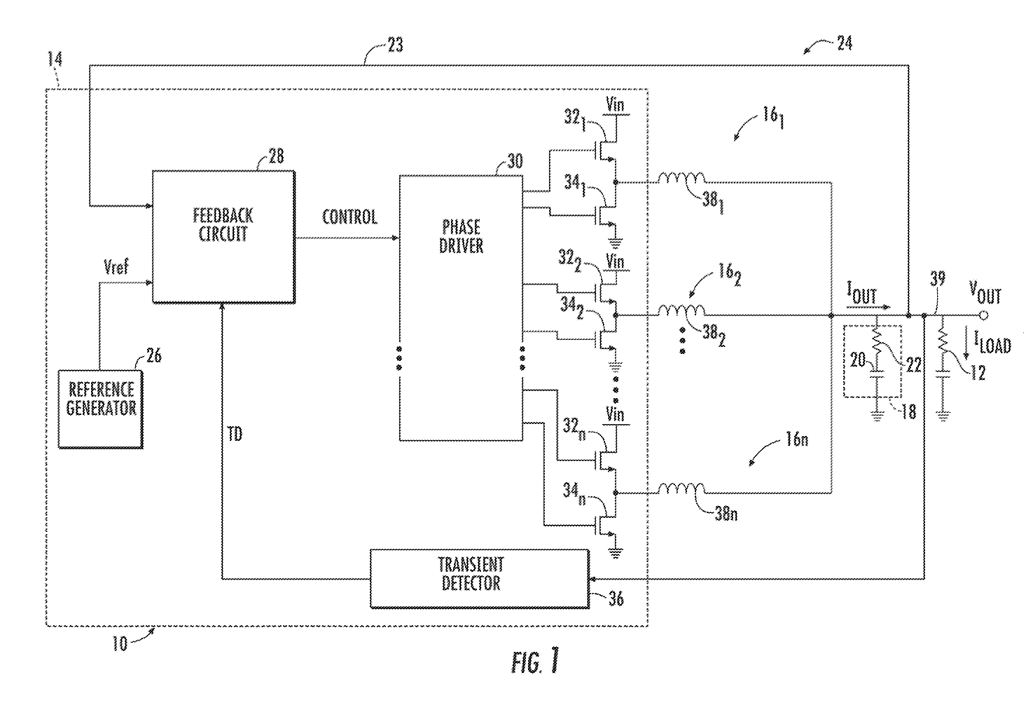

FIG. 1 is a schematic diagram of an embodiment of a dual-mode power supply 10 and a load 12 that is powered by a regulated output signal (a regulated output voltage Vₒᵤₜ in this embodiment) that is generated by the supply. As discussed below, the power supply 10 has a lower control-loop bandwidth during steady-state operation (i.e., operates in a steady-state mode when the load current has a substantially constant average value such that the current output by the power supply is substantially constant) and a higher control-loop bandwidth during transient operation (i.e., operates in a transient mode when the load current, and thus the current output by the power supply, changes significantly over a relatively short period of time). The lower control-loop bandwidth during steady-state operation may increase the steady-state noise rejection of the power supply 10, and thus may reduce jitter in the supply's steady-state switching frequency. And the higher control-loop bandwidth during transient operation may allow the power supply 10 to respond more quickly to a load transient, and thus may allow the supply to more quickly bring the output signal back to its regulated value. Known single-mode power supplies may have a fixed loop bandwidth that is selected as a trade off between steady-state and transient performance. But with the dual-mode supply 10, one may not need to make such a trade off.

The power supply 10 includes a power-supply controller 14, at least one power-supply phase 16₁-16ₙ, and at least one filter capacitor 18, which may be modeled as an ideal capacitor 20 an equivalent series resistance (ESR) 22. The controller 14, phases 16₁-16ₙ, capacitor 18, and a feedback path 23, which couples Vₒᵤₜ to an input node of the controller, together form a power-supply control loop 24. Although the load 12 is typically not considered part of the control loop 24, the impedance of the load may affect the frequency response of the control loop.

The power-supply controller 14 includes a reference generator 26, a feedback circuit 28, a phase driver 30, high-side NMOS switching transistors 32₁-32ₙ, low-side NMOS switching transistors 34₁-34ₙ, and a transient detector 36.

The reference generator 26 is operable to generate a stable reference signal, in this embodiment a reference voltage V_{ref}.

The feedback circuit 28 is operable to receive the regulated output signal Vₒᵤₜ and the reference signal V_{ref}, and, from these signals, is operable to generate a signal CONTROL, which the feedback circuit generates to maintain Vₒᵤₜ substantially equal to V_{ref} (or to a voltage derived from V_{ref}). The feedback circuit 28 may also include compensation for stabilizing the control loop 24, and the feedback circuit or another portion of the power-supply controller 14 may have the ability to set this compensation according to the impedance of the load 12 so as to maintain the stability of the control loop 24 over a range of load impedances. Furthermore, the feedback circuit 28 is operable to receive a transient-detection signal TD from the transient detector 36, and is operable to alter the control-loop compensation in response to TD. For example, as discussed below, the feedback circuit 28 may temporarily increase its own bandwidth, and thus may temporarily increase the bandwidth of the control loop 24, in response to the signal TD.

The phase driver 30 controls the switching of the transistors 32 and 34 under the direction of the signal CONTROL. More specifically, the phase driver 30 controls the duty cycles of the phases 16₁-16ₙ—the duty cycle of a phase is the percentage of the phase's switching period during which the corresponding high-side transistor 32 is conducting (i.e., is “on”)—so as to maintain Vₒᵤₜ substantially equal to V_{ref} or to a voltage derived from V_{ref} (e.g., with a voltage divider).

Each of the high-side NMOS transistors 32₁-32ₙ has a drain coupled to receive a first input voltage Vᵢₙ, a gate coupled to the phase driver 30, and a source coupled to an input of a respective phase 16₁-16ₙ.

Each of the low-side NMOS transistors 34₁-34ₙ has a drain coupled to an input of a respective phase 16₁-16ₙ, a gate coupled to the phase driver 30, and a source coupled to a second input voltage, which is ground in this embodiment.

The transient detector 36 detects a relatively sudden change in the current I_{load} drawn by the load 12, and generates the signal TD in response to detecting such a change. Furthermore, the detector 36 may detect not only the presence of a load transient, but also may detect the polarity of the transient. That is, the detector 36 may determine whether the load current I_{load} has increased or decreased. The detector 36 may detect a change in I_{load} by detecting a change in Vₒᵤₜ. That is, if the detector 36 senses that the magnitude of Vₒᵤₜ has increased above to a first threshold, then the detector determines that I_{load} has decreased to below a second threshold. Conversely, if the detector 36 senses that the magnitude of Vₒᵤₜ has decreased to below a third threshold, then the detector determines that I_{load} has increased to above a fourth threshold. Furthermore, the detector 36 may generate TD only temporarily, e.g., for a specified duration, in response to a load transient so that the feedback circuit 28 returns the transient-mode bandwidth of the control loop 24 to its steady-state-mode value after the transient in I_{load} has sufficiently dissipated. Alternatively, the detector 36 may generate TD until load or Vₒᵤₜ has returned to within a respective threshold window.

Each phase 16₁-16ₙ includes at least a respective filter inductor 38₁-38ₙ, each inductor having a respective input end coupled to the drain of the corresponding high-side transistor 32₁-32ₙ and to the source of the corresponding low-side transistor 34₁-34ₙ, and having a respective output end coupled to the output node 39 on which Vₒᵤₜ is present. Although not shown in FIG. 1, each phase 16₁-16ₙ may include one or more components in addition to the respective inductor 38₁-38ₙ.

The load 12 may be any type of load. For example, the load 12 may be a processor (not shown in FIG. 1) that significantly increases load when it awakens from a sleep state, and that significantly decreases I_{load} when it enters a sleep state.

Still referring to FIG. 1, the operation of an embodiment of the power supply 10 is discussed.

During steady-state operation, the current Iₒᵤₜ, which is the current output by the at least one phase 16, is substantially constant, and the power-supply controller 14 operates in a steady-mode to maintain the amplitude of Vₒᵤₜ at a substantially constant value, e.g., 1.1 Volts (V), that is set by V_{ref}.

During a period of transient operation that commences when the load current I_{load} increases to above a first threshold level over a relatively short period of time (e.g., microseconds or nanoseconds), Vₒᵤₜ decreases to below a corresponding second threshold level. The transient detector 36, which may set this second threshold level, detects this decrease in Vₒᵤₜ. In response to the detected decrease in Vₒᵤₜ, the transient detector 36 generates the signal TD, which causes the power-supply controller 14 to enter a transient mode of operation. In response to the signal TD, the feedback circuit 28 increases its bandwidth (as compared to its bandwidth in the steady-state mode), and thus increases the bandwidth of the control loop 24. With this increased bandwidth, the control loop 24 acts more quickly than it otherwise would to increase Iₒᵤₜ toward the new steady-state value of I_{load}, and to thus raise Vₒᵤₜ back toward its regulated value as set by V_{ref}. That is, this increased bandwidth allows the control loop 24 to reduce the length of the transient period as compared to the length that the transient period might have if the control loop retained its lower steady-state bandwidth. The feedback circuit 28 may increase the bandwidth of the control loop 24 for a set time, for example, a time set at least in part by the duration of the signal TD. Alternatively, the feedback circuit 28 may increase the bandwidth of the control loop 24 until the transient detector 36 stops generating the signal TD in response to detecting that Vₒᵤₜ has risen above a third threshold, which may be the same as or different than the second threshold.

Similarly, during a period of transient operation that commences when the load current load decreases to below a fourth threshold level over a relatively short period of time, Vₒᵤₜ increases to above a corresponding fifth threshold level. The transient detector 36, which may set this fifth threshold level, detects this increase in Vₒᵤₜ. In response to the detected increase in Vₒᵤₜ, the transient detector 36 generates the signal TD, which, as discussed above, causes the power-supply controller to enter the transient mode of operation. In response to the signal TD, the feedback circuit 28 increases its bandwidth (as compared to its bandwidth in the steady-state mode), and thus increases the bandwidth of the control loop 24. With this increased bandwidth, the control loop 24 acts more quickly than it otherwise would to decrease Iₒᵤₜ toward the new steady-state value of I_{load}, and to thus lower Vₒᵤₜ back toward its regulated value as set by V_{ref}. That is, this increased bandwidth allows the control loop 24 to reduce the length of the transient period as compared to the length that the transient period might have if the control loop retained its lower steady-state bandwidth. The feedback circuit 28 may increase the bandwidth of the control loop 24 for a set time as discussed above. Alternatively, the feedback circuit 28 may increase the bandwidth of the control loop until the transient detector 36 stops generating the signal TD in response to detecting that Vₒᵤₜ has fallen below a sixth threshold, which may be the same as or different than the fifth threshold.

Still referring to FIG. 1, alternate embodiments of the power supply 10 are contemplated. For example, instead of regulating Vₒᵤₜ, the supply 10 may regulate Iₒᵤₜ, and sense Iₒᵤₜ by employing a sense resistor (not shown in FIG. 1) in series with the load 12. In addition, although the power-supply controller 14 is shown as including the transistors 32 and 34, these transistors may be part of the respective phases 16. Moreover, the reference generator may not be part of the controller 14. Furthermore, although shown as being NMOS transistors, the transistors 32 and 34 may each be any other suitable type of transistor or other power device such as an IGBT. In addition, although described as increasing the bandwidth of the control loop 24 in response to a load transient, the feedback circuit 28 may alter one or more other characteristics of the control loop in response to a load transient. For example, the feedback circuit 28 may increase the gain, or both the gain and the bandwidth, of the control loop 24 in response to a load transient. In addition, some or all of the components of the power-supply 10 may be disposed on a same integrated-circuit (IC) die (not shown in FIG. 1). For example, all the components of the power-supply controller 14 may be disposed on a same IC die, or the transistors 32 and 34 may be omitted from this IC die. Or, the entire power supply 10 and the load 12 may be disposed on the same IC die as part of a system on a chip (SoC).

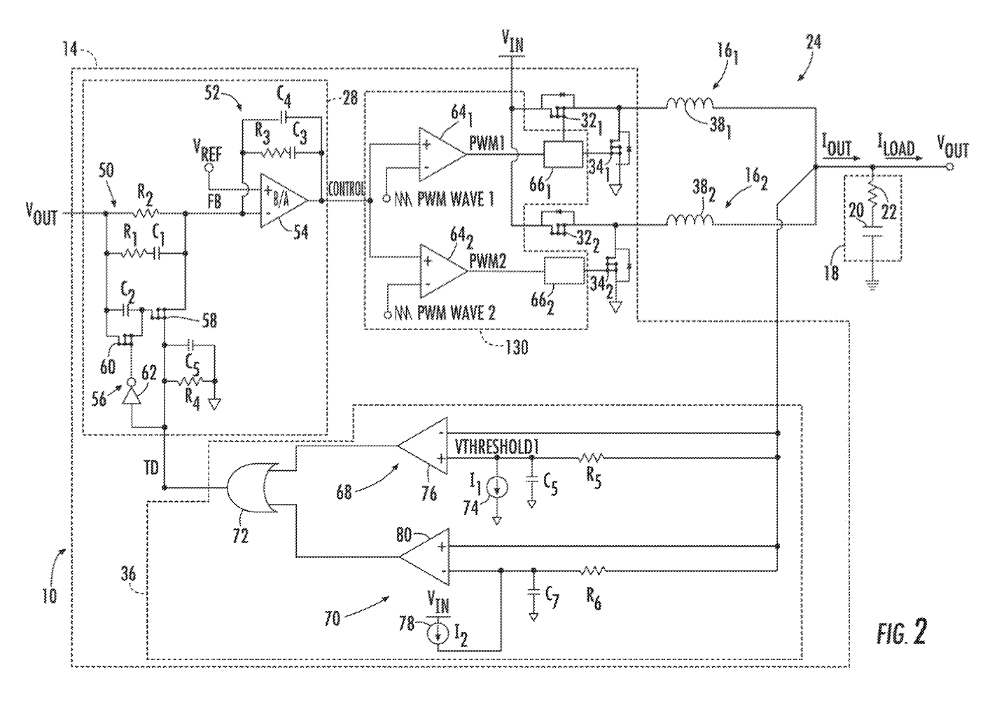

FIG. 2 is a more detailed schematic diagram of a two-phase embodiment of the dual-mode power supply 10 of FIG. 1, where like numerals reference components common to the embodiments of FIGS. 1 and 2. Although the reference generator 26 is omitted from FIG. 2 for brevity, it may still be a part of the power-supply controller 14.

The feedback circuit 28 includes a first compensation network 50, a second compensation network 52, an error amplifier 54, and adjusting circuitry 56, which is operable to change the frequency response (and thus the compensation) provided by the first network 50 in response to the signal TD.

The first compensation network 50 generates a feedback signal FB from Vₒᵤₜ, and includes a first resistor R₁, a first capacitor C₁, a second resistor R₂ in parallel with the series combination of R₁ and C₁, a serially coupled second capacitor C₂ and NMOS transistor 58, which are in parallel with the series combination of R₁ and C₁, and an NMOS transistor 60, which is in parallel with C₂. As discussed below, the circuitry 56 may activate or deactivate the transistors 58 and 60 to change the frequency response of the network 50. While the transistor 58 is inactive and the transistor 60 is active, the “off” resistance of the transistor 58, the “on” resistance of the transistor 60, and the second capacitor C₂ do not affect the frequency response of the network 50. That is, while the transistor 58 is inactive and the transistor 60 is active, the frequency response of the network 50 is substantially set by R₁, R₂, and C₁ only. Specifically, while the transistor 58 is inactive and the transistor 60 is active, the network 50 adds to the control loop 24 in a known manner a zero in the s (Laplace Transform) plane, where the location of this zero is set substantially by R₁, R₂, and C₁. But while the transistor 58 is active and the transistor 60 is inactive, the frequency response of the first network 50 is substantially set by R₁, R₂, C₁, C₂, and the “on” resistance R_{DSON} of the transistor 58 such that the first network adds two zeros to the control loop 24, and thus increases the bandwidth of the control loop. That is, while the transistor 58 is inactive and the transistor 60 is active, the control loop 24 has a lower bandwidth (steady-state mode), and while the transistor 58 is active and the transistor 60 is inactive, the control loop has a higher bandwidth (transient mode).

The second compensation network 52, which is coupled between the inverting input node and the output node of the error amplifier 54, includes a third resistor R₃, a third capacitor C₃, and a fourth capacitor C₄ in parallel with the series combination of R₃ and C₃. The network 52 adds to the control loop 24 two poles in the s plane in a known manner.

The error amplifier 54 may be a conventional, high-gain differential amplifier, such as an operational amplifier. A noninverting input node of the amplifier 54 receives V_{ref}, and the inverting input node receives FB from the first network 50. The amplifier 54 generates the CONTROL signal so that ideally, Vₒᵤₜ=FB=V_{ref} for a constant value of out. But in actuality, offset and other errors introduced by the amplifier 54 may cause Vₒᵤₜ ˜FB˜V_{ref} for a constant value of Iₒᵤₜ.

The adjusting circuitry 56 includes an inverter 62, and an optional fourth resistor R₄ and fifth capacitor C₅, which, when present, are coupled in parallel between the gate of the transistor 58 and ground. The inverter 62 receives on an input node the transient-detect signal TD from the transient detector 36, and drives the gate of the transistor 60 with an output node. As discussed below, the transient detector 36 generates TD as a digital signal having a low level during the steady-state operating mode of the power supply 10 and transitions TD to a high-level in response to a load transient to cause the power supply to enter its transient operating mode. In an embodiment where R₄ and C₅ are omitted, while TD is low, the transistor 58 is inactive and the transistor 60 is active, thus causing the control loop 24 to have a lower bandwidth during steady-state operation as discussed above. And while TD is high, the transistor 58 is active and the transistor 60 is inactive, thus causing the control loop 24 to have a higher bandwidth during transient operation as discussed above. Therefore, one may set the duration of the transient operating mode (during which the control loop 24 has a higher bandwidth) by setting the duration of TD. But in an embodiment where R₄ and C₅ are present, these two components slow the rise and fall times of TD. A result of the slowed fall time of TD is that the transistors 58 and 60 remain active and inactive, respectively, for a longer time (as measured from the moment when TD transitions from a high level) relative to the embodiment where R₄ and C₅ are omitted. Therefore, one may set the duration of the transient operating mode by selecting the appropriate values of R₄ and C₅, setting the duration of TD, or both selecting the values of R₄ and C₅ and setting the duration of TD.

The phase driver 30 includes two comparators 64₁ and 64₂, and two switch drivers 66₁ and 66₂, one comparator and switch driver per phase 16.

The comparator 64₁ receives at a noninverting input node the signal CONTROL, and receives at an inverting input node a pulse-width-modulating (PWM) WAVE₁, such as a triangle wave, sawtooth wave, or other wave having a frequency F_{sw} and at least an increasing-amplitude portion and a decreasing-amplitude portion, where the increasing portion, decreasing portion, or both the increasing and decreasing portions may be linear. Although not shown, a circuit for generating PWM WAVE₁ may be part of the power-supply controller 14 or may be located elsewhere. At an output node, the comparator 64₁ generates a signal PWM₁, which causes the switch driver 66₁ to drive the transistors 32₁ and 34₁ in a pulse-width-modulated (PWM) manner. Generally, the signal PWM₁ has a substantially constant frequency equal to F_{sw}, and the amplitude of the signal CONTROL modulates the duty cycle of PWM₁ in a manner that maintains Vₒᵤₜ˜V_{ref} during a steady-state mode of operation, and that drives Vₒᵤₜ toward V_{ref} during a transient mode of operation. Because pulse-width modulation is known, it is not discussed further herein.

The comparator 64₂ is similar in topology and operation to the comparator 64₁, except that the signal PWM WAVE₂ may be out of phase with PWM WAVE₁ by 360°/n, where n is the number (two in this embodiment) of phases in the power supply 10. Shifting the phase of PWM WAVE₂ by substantially 360°/2=180° relative to the phase of PWM WAVE₁ allows the power-supply controller 14 to reduce the amplitude of the ripple component of Vₒᵤₜ by driving the power-supply phase 16₁ 180° out of phase relative to the power-supply phase 16₂.

The switch driver 66₂ drives the transistors 32₁ and 34₁ in a complementary manner in response to the signal PWM₁. That is, when the driver 66₁ activates the transistor 32₁, it deactivates the transistor 34₁, and vice versa. In an embodiment, the driver 66₁ is an inverter. In another embodiment, the driver 66₁ is conventionally designed to insure that the transistors 32₁ and 34₁ are not simultaneously active. Such a design may prevent a large “crow bar” current from flowing from Vᵢₙ, through the transistors 32₁ and 34₁, to ground.

The switch driver 66₂ drives the transistors 32₂ and 34₂ in a complementary manner in response to the signal PWM₂ in a manner similar to that described above for the switch driver 66₁.

Still referring to FIG. 2, the transient detector 36 includes a load-increase detection path 68, a load-decrease detection path 70, and an OR gate 72.

The path 68 detects a transient caused by an increase in the current I_{load}, and includes a resistor R₅, capacitor C₆, current source 74, and comparator 76. The current source 72 sets a detection threshold by generating a voltage drop I₁·R₅ across the resistor R₅, such that a threshold voltage V_{threshold1}, which is substantially equal to Vₒᵤₜ_{_{—}}_{steady}_{_{—}}ₛₜₐₜₑ−I₁·R₅, is present at the noninverting node of the comparator 76. Furthermore, R₅ and C₆ form a low-pass filter that effectively holds the noninverting node of the comparator 76 at substantially V_{threshold1} during a transient increase in I_{load}. Therefore, in response to such a transient increase in I_{load}, if Vₒᵤₜ decreases to below V_{threshold1}, then the output of the comparator 76 transitions from a low level to a high level, thus causing the OR gate 72 to generate the signal TD having a high level. As discussed above, a high level for TD enters the power-supply 10 into a transient-operating mode during which the control loop 24 has a higher bandwidth that allows the power-supply controller 14 to more quickly bring Vₒᵤₜ back to its regulated value. After Vₒᵤₜ returns to a level that is above V_{threshold1}, then the output of the comparator 76 transitions from a high level to a low level, thus causing the OR gate 72 to generate the signal TD having a low level, or causing the OR gate to tri-state its output node, as discussed below.

The path 70 detects a transient caused by an decrease in the current I_{load}, and includes a resistor R₆, capacitor C₇, current source 78, and comparator 80. The current source 78 sets a detection threshold by generating a voltage drop I₂·R₆ across the resistor R₆, such that a threshold voltage V_{threshold2}, which is substantially equal to Vₒᵤₜ_{_{—}}_{steady}_{_{—}}ₛₜₐₜₑ−I₂·R₆, is present at the inverting node of the comparator 80. Furthermore, R₆ and C₇ form a low-pass filter that effectively holds the inverting node of the comparator 80 at substantially V_{threshold2} during a transient decrease in I_{load}. Therefore, in response to such a transient decrease in I_{load}, if Vₒᵤₜ increases to above V_{threshold2}, then the output of the comparator 80 transitions from a low level to a high level, thus causing the OR gate 72 to generate the signal TD having a high level. After Vₒᵤₜ returns to a level that is below V_{threshold2}, the output of the comparator 80 transitions from a high level to a low level, thus causing the OR gate 72 to generate the signal TD having a low level, or causing the OR gate to tri-state its output node, as discussed below.

In an embodiment where R₄ and C₅ of the circuitry 56 are omitted, then the OR gate 72 may be a conventional OR gate that generates TD having a high level (e.g., ˜Vᵢₙ) if at least one of the comparators 76 and 80 is outputting a high level, and that generates TD having a low level (e.g., ground) if both of the comparators are outputting low levels.

But in an embodiment where R₄ and C₅ are present, a conventional OR gate 72 may have an output impedance that is much less than R₄ while the signal TD has a low level, and this output impedance may effectively negate the intended effect of R₄ and C₅, this intended effect at least in part being the slowing of the fall time of the signal TD.

Therefore, where R₄ and C₅ are present, the OR gate 72 may be designed to tristate its output (i.e., present a high output impedance) when the outputs of both the comparators 76 and 80 have low levels. Consequently, when at least one of the comparators 76 and 80 transitions its output to a high level, the OR gate transitions the signal TD to a high level to increase the bandwidth of the control loop 24, and to thus cause the power supply 10 to enter the transient operating mode. But when the at least one comparator transitions its output back to a low level, the OR gate will tristate its output, thus allowing the signal TD to decay from a high level to a low level at a rate that is set by R₄ and C₅, and thus allowing the power supply 10 to remain in the transient operating mode for a time that is at least partially set by R₄ and C₅.

Still referring to FIG. 2, one may design the feedback circuit 28 such that during the steady-state operating mode of the power supply 10, the bandwidth of the control loop 24 is sufficiently low to provide the control loop with a specified stability margin and to provide a switching-frequency jitter that is below a specified level. For example, it is known that in an embodiment, a maximum stable steady-state bandwidth of the control loop 24 is F_{sw}/2. Therefore, one may design the feedback circuit 28 such that the control loop 24 has a steady-state bandwidth that is less than F_{sw}/2, for example, a steady-state bandwidth that is between F_{sw}/3 and F_{sw}/4.

Furthermore, one may design the feedback circuit 28 such that during the transient operating mode of the power supply 10, the bandwidth of the control loop 24 is sufficiently high to allow the control loop to force Vₒᵤₜ back to its regulated level (or to within a specified range of its regulated level) within a specified time. Because the power supply 10 operates in the transient mode for only a relatively short period of time, one may design the feedback circuit 28 such that the control loop 24 has a transient-mode bandwidth that is significantly greater than F_{sw}/2 without causing the power supply to oscillate. For example, one may design the feedback circuit 28 such that the control loop 24 has transient-mode bandwidth of between approximately ⅔·F_{sw} and 10·F_{sw}.

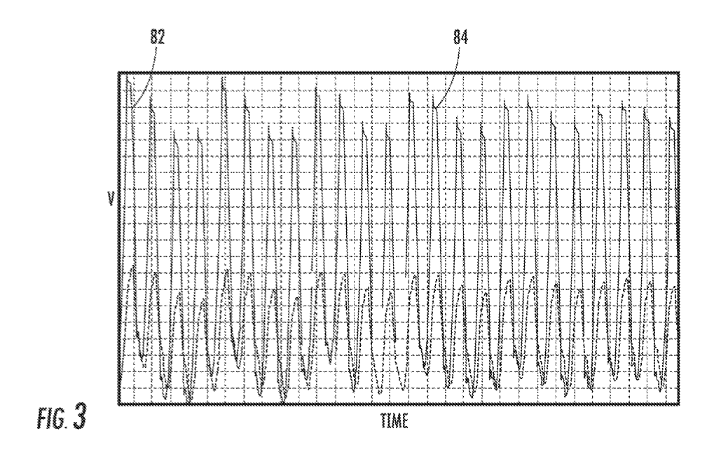

FIG. 3 is a timing diagram that compares the noise amplitude superimposed on a version 82 of the signal CONTROL with the noise amplitude superimposed on a version 84 of the signal CONTROL. The version 82 is generated by the error amplifier 54 while the dual-mode power supply 10 is in the steady-state operating mode (lower loop bandwidth yields a lower noise amplitude). The version 84 of the signal CONTROL might be generated under similar load conditions by the error amplifier of a signal-mode power supply that is similar to the power supply 10 but that has a fixed loop bandwidth that is higher than the steady-state bandwidth of the loop 24 (higher loop bandwidth yields a higher noise amplitude). For example, such a single-mode power supply may be the same as the power supply 10 but without the transient detector 36, the adjust circuit 56, the transistors 58 and 60, and the capacitor C₂.

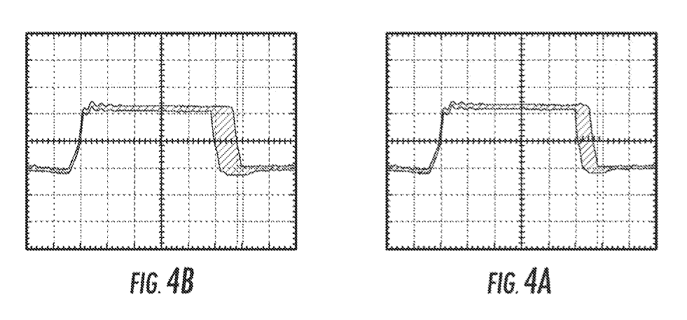

FIG. 4A is a timing diagram showing jitter in the phase 16₁ drive signal at the source of the transistor 32₁ while the dual-mode power supply 10 is in the steady-state operating mode. This timing diagram shows that a lower steady-state control-loop bandwidth may yield a lower level of jitter in the phase drive signal, and thus may yield a lower level of jitter in the power-supply switching frequency.

FIG. 4B is a timing diagram showing possible jitter in the phase 16₁ drive signal at the source of the transistor 32₁ of a signal-mode power supply that is similar to the power supply 10 but that has a fixed loop bandwidth that is higher than the steady-state bandwidth of the loop 24. For example, such a single-mode power supply may be the same as the power supply 10 but without the transient detector 36, the adjust circuit 56, the transistors 58 and 60, and the capacitor C2. This timing diagram shows that a higher steady-state control-loop bandwidth may yield a higher level of jitter in the phase drive signal, and thus may yield a higher level of jitter in the power-supply switching frequency.

Referring to FIGS. 2-4B, the steady-state mode of operation of an embodiment of the dual-mode power supply 10 is described.

Referring to FIG. 2, during steady-state operation, the current I_{load} is approximately constant, and the signal TD has a low level such that the control loop 24 has a lower bandwidth. The error amplifier 54 generates the signal CONTROL having a level that forces FB=V_{ref} (as stated above, FB may not exactly equal V_{ref} due to offset errors in the amplifier 54 and possibly other causes). To force FB=V_{ref}, the phase driver 30 and the transistors 32₁-32₂ and 34₁-34₂ drive the respective phases 16₁ and 16₂ 180° out of phase and with duty cycles that cause Iₒᵤₜ to have an average value that is ideally equal to the average value of I_{load} (in actuality, the average value of Iₒᵤₜ may not exactly equal the average value of I_{load}). If I_{load} changes relatively slowly over time, then the error amplifier 54 tracks these changes by adjusting the value of the signal CONTROL such that the phase driver 30 and transistors 32 and 34 continue to force FB=V_{ref} and to force the average value of Iₒᵤₜ equal to the average value of I_{load}.

Referring to FIGS. 2-3 and 4B, if one were to omit the transient detector 36, the bandwidth-adjusting circuit 56, the transistors 58 and 60, and the capacitor C₂ from the power supply 10 and merely fix the bandwidth of the control loop 24 high enough to provide the desired transient response, then this higher bandwidth might impose a higher noise amplitude on the signal CONTROL during steady-state operation, and this higher noise amplitude might cause a higher level of jitter in the phase drive signals (only the phase 16₁ switching signal is shown in FIG. 4A, although the jitter for the phase 16₂ switching signal may be similar). And this higher level of jitter in the phase drive signals might cruse a higher level of jitter in the steady-state power-supply switching frequency.

In contrast, referring to FIGS. 2-4A, including the transient detector 36, the bandwidth-adjust circuit 56, the transistors 58 and 60, and the capacitor C₂ in the power supply 10 to lower the bandwidth of the control loop 24 during steady-state operation may reduce the noise amplitude on the signal CONTROL, and thus may reduce the level of jitter in the phase drive signals (only the phase 16₁ switching signal is shown in FIG. 4A, although the reduced level of jitter for the phase 16₂ switching signal may be similar). And this lower level of signals may reduce the level of jitter in the steady-state power-supply switching frequency.

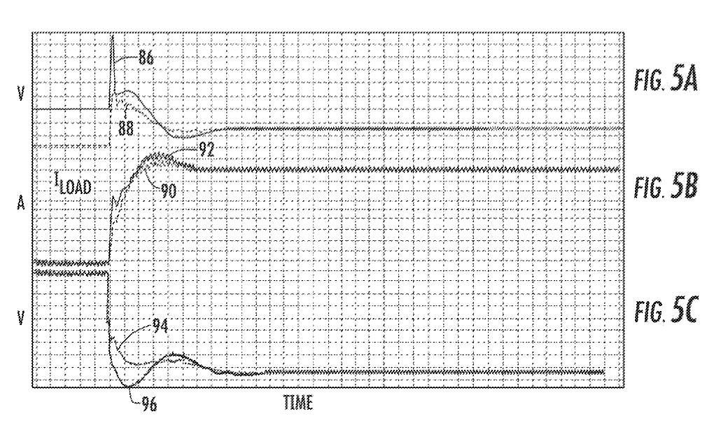

FIG. 5A is a timing diagram that compares a version 86 of the signal CONTROL with a version 88 of the signal CONTROL. The version 86 corresponds to a step increase in I_{load} (shown in FIG. 5B) while the dual-mode power supply 10 of FIG. 2 is in the transient mode. The version 88 corresponds to a step increase in I_{load} for a single-mode power supply that is similar to the power supply 10 of FIG. 2 but that has a fixed loop bandwidth that is lower than the transient bandwidth of the loop 24. For example, such a single-mode power supply may be the same as the power supply 10 but without the transient detector 36, the adjust circuit 56, the transistors 58 and 60, and the capacitor C₂.

FIG. 5B is a timing diagram that compares a version 90 of Iₒᵤₜ with a version 92 of Iₒᵤₜ. The version 90 corresponds to a step increase in I_{load} while the dual-mode power supply 10 of FIG. 2 is in the transient mode. The version 92 corresponds to a step increase in I_{load} for a single-mode power supply that is similar to the power supply 10 of FIG. 2 but that has a fixed loop bandwidth that is lower than the transient bandwidth of the loop 24.

FIG. 5C is a timing diagram that compares a version 94 of Vₒᵤₜ with a version 96 of Vₒᵤₜ. The version 94 corresponds to a step increase in I_{load} (shown in FIG. 5B) while the dual-mode power supply 10 of FIG. 2 is in the transient mode. The version 96 corresponds to a step increase in I_{load} for a single-mode power supply that is similar to the power supply 10 of FIG. 2 but that has a fixed loop bandwidth that is lower than the bandwidth of the loop 24.

Referring to FIGS. 2 and 5A-5C, the transient mode of operation of an embodiment of the dual-mode power supply 10 is described.

During a transient mode of operation that is initiated by I_{load} significantly increasing (e.g., a step increase in I_{load} per FIG. 5B), the detection path 68 detects Vₒᵤₜ falling below V_{threshold1}, and in response to this detection, the OR gate 72 transitions the signal TD to a high level. In response to the high level for TD, the adjust circuit 56 increases the bandwidth of the first compensation network 50 (and thus increases the bandwidth of the control loop 24) as described above, and thus allows the amplitude of the feedback signal FB to more quickly (as compared to the first compensation network having its lower steady-state bandwidth) decrease in response to the transient decrease in Vₒᵤₜ. The error amplifier 54 senses this transient decrease in FB, and increases the amplitude of the signal CONTROL accordingly. Referring to FIG. 5A, one can see that the increased transient-mode bandwidth of the control loop 24 allows the amplifier 54 to increase the amplitude of the signal CONTROL (version 86) more quickly than if the control loop did not have an increased bandwidth (version 88). This increase in the amplitude of the signal CONTROL increases the on time of the transistors 32₁ and 32₂, and thus increases the duty cycles of the phases 16₁ and 16₂. This increase in the phase duty cycles increases the average value of Iₒᵤₜ (I_{outaverage}) toward the new, higher average value of load (I_{loadaverage}). This increase in Iₒᵤₜ increases Vₒᵤₜ back toward its regulated level, and thus increases FB back toward V_{ref}. Referring to FIGS. 5B-5C, one can also see that the increased bandwidth of the control loop 24 allows Iₒᵤₜ and Vₒᵤₜ to settle to within respective specified ranges of their respective steady-state levels more quickly and with less overshoot and undershoot (versions 90 and 94, respectively) than if the control loop did not have an increased bandwidth (versions 92 and 96, respectively) during this transient. Furthermore, in one embodiment, FB=V_{ref} and I_{outaverage}=I_{loadaverage} before the signal TD transitions or decays back to a low level. In another embodiment, FB moves toward V_{ref} and I_{outaverage} moves toward I_{loadaverage} while TD still has a high level, but FB does not equal V_{ref} and I_{outaverage} does not equal loadaverage until after TD transitions or decays back to a low level.

Furthermore, referring to FIG. 5C, one may notice that Vₒᵤₜ has different regulated levels for different levels of load. The difference between the two levels of Vₒᵤₜ is due to a phenomenon called droop, and may be on the order of ones to tens of millivolts when droop is present, the regulated level of Vₒᵤₜ may depend at least slightly on Iₒᵤₜ. Because droop is known, it is not discussed further. But the presence of droop is contemplated for an embodiment of the power supply 10.

Referring again to FIG. 2, during a transient mode of operation that is initiated by load significantly decreasing (e.g., a step decrease in I_{load}), the detection path 70 detects Vₒᵤₜ rising above V_{threshold2}, and in response to this detection, the OR gate 72 transitions the signal TD to a high level. In response to the high level for TD, the adjust circuit 56 increases the bandwidth of the first compensation network 50 (and thus increases the bandwidth of the control loop 24) as described above, and thus allows the amplitude of the feedback signal FB to more quickly (as compared to the first compensation network having its lower steady-state bandwidth) increase in response to the transient increase in Vₒᵤₜ. The error amplifier 54 senses this transient increase in FB, and decreases the amplitude of the signal CONTROL accordingly. The increased bandwidth of the control loop 24 allows the amplifier 54 to decrease the amplitude of the signal CONTROL more quickly than if the control loop did not have an increased bandwidth. This decrease in the amplitude of the signal CONTROL decreases the on time of the transistors 32₁ and 32₂, and thus decreases the duty cycles of the phases 16₁ and 16₂. This decrease in the phase duty cycles decreases I_{outaverage} toward the new, lower I_{loadaverage}. This decrease in Iₒᵤₜ decreases Vₒᵤₜ back toward its regulated level, and thus decreases FB back toward V_{ref}. The increased bandwidth of the control loop 24 allows Iₒᵤₜ and Vₒᵤₜ to settle to within respective specified ranges of their respective steady-state levels more quickly and with less overshoot and undershoot than if the control loop did not have an increased bandwidth during this transient. Furthermore, in one embodiment, FB=V_{ref} and I_{outaverage}=I_{loadaverage} before the signal TD transitions or decays back to a low level. In another embodiment, FB moves toward V_{ref} and I_{outaverage} moves toward I_{loadaverage} while TD still has a high level, but FB does not equal V_{ref} and I_{outaverage} does not equal I_{loadaverage} until after TD transitions or decays back to a low level.

Referring to FIG. 2, alternate embodiments of the power supply 10 are contemplated. For example, although shown as having two phases 16₁-16₂, the power supply 10 may include fewer or more than two phases. Furthermore, the network 50 (or other circuitry with an adjustable frequency response) may be located in a portion of the control loop 24 other than the feedback circuit 28. In addition, the transient detector 36 may include only one of the detection paths 68 and 70. For example, if one designs the power supply 10 to have a transient operating mode only for a transient caused by an increase in I_{load}, then the path 70 may be omitted. Moreover, although the power supply 10 is described as being a PWM buck converter, the power supply may be any other type of power supply, such as a constant-on-time supply, constant-off-time supply, or buck-boost supply. Furthermore, although the inductors 38₁ and 38₂ are described as being magnetically isolated from one another, these inductors may be magnetically coupled to one another (and to the inductors of any other phases of the supply). In addition, any of the disclosed circuit topologies may be redesigned to perform the same or a similar function as the corresponding disclosed topology.

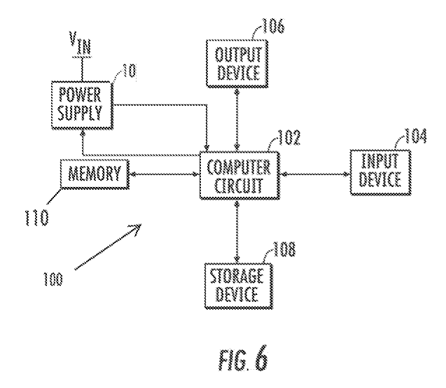

FIG. 6 is a block diagram of an embodiment of a system 100 (a computer system in this embodiment), which may include an embodiment of at least one of the power supplies 10 of FIGS. 1 and 2.

The system 100 includes at least one computer circuit 102 for performing computer functions, such as executing software to perform desired calculations and tasks. The circuit 102 may include a controller, processor, or one or more other integrated circuits (ICs).

At least one input device 104, such as a keyboard or a mouse, is coupled to the computer circuitry 102 and allows an operator (not shown) to manually input data thereto.

At least one output device 106 is coupled to the computer circuit 102 to provide to the operator data generated by the computer circuit. Examples of such an output device 106 include a printer and a video display unit.

At least one data-storage device 108 is coupled to the computer circuit 102 to store data on or retrieve data from external storage media (not shown). Examples of the storage device 108 and the corresponding storage media include drives that accept hard and floppy disks, tape cassettes, compact disk read-only memories (CD-ROMs), and digital-versatile disks (DVDs).

At least one memory 110 is coupled to the computer circuit 102, and stores data that the computer circuit may generate or on which the computer circuit may operate.

The power supply 10 provides at least one supply voltage to the computer circuit 102, and although not shown, may provide at least one respective supply voltage to at least one of the input device 104, output device 106, storage device 108, and memory 110.

Furthermore, one or at least any two of the power supply 10, computer circuit 102, input device 104, output device 106, storage device 108, and memory 110 may be disposed on a single integrated-circuit (IC) die, or otherwise within a same IC package.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

What is claimed is:

1. A power-supply controller, comprising:
a control circuit having a signal characteristic and operable to generate a regulated output signal; and
a detection circuit operable to detect a change in the regulated output signal and to alter the signal characteristic of the control circuit in response to the detected change.

2. The power-supply controller of claim 1 wherein the control circuit is operable to cause at least one power-supply phase to generate the regulated output signal.

3. The power-supply controller of claim 1 wherein the control circuit is operable to generate the regulated output signal in response to the regulated output signal and a reference signal.

4. The power-supply controller of claim 1 wherein:
the control circuit is operable to cause at least one power-supply phase to generate the regulated output signal; and
the control circuit is operable to generate the regulated output signal in response to the regulated output signal and a reference signal.

5. The power-supply controller of claim 4 wherein the control circuit comprises:
a comparison circuit that is operable to generate a control signal in response to the regulated output signal and the reference signal; and
a phase driver operable in response to the control signal to cause the at least one power-supply phase to generate the regulated output signal.

6. The power-supply controller of claim 1 wherein the signal characteristic of the control circuit comprises a bandwidth of the control circuit.

7. The power-supply controller of claim 1 wherein:
the signal characteristic of the control circuit comprises a bandwidth of the control circuit; and
the detection circuit is operable to increase the bandwidth of the control circuit in response to the detected change in the regulated output signal.

8. The power-supply controller of claim 1 wherein the signal characteristic of the control circuit comprises a gain of the control circuit.

9. The power-supply controller of claim 1 wherein:
the signal characteristic of the control circuit comprises a gain of the control circuit; and
the detection circuit is operable to increase the gain of the control circuit in response to the detected change in the regulated output signal.

10. The power-supply controller of claim 5 wherein the comparison circuit comprises an amplifier having an inverting node operable to receive the output signal, a noninverting node operable to receive the reference signal, and an output node operable to provide the control signal.

11. The power-supply controller of claim 3 wherein:
the regulated output signal comprises a regulated output voltage; and
the reference signal comprises a reference voltage.

12. The power-supply controller of claim 5 wherein the phase driver is also operable in response to a substantially periodic reference signal having substantially linearly increasing and substantially linearly decreasing amplitude portions to cause the least one power-supply phase to generate the regulated output signal.

13. The power-supply controller of claim 1 wherein the detection circuit is operable to detect a change in an amplitude of the regulated output signal.

14. The power-supply controller of claim 1 wherein the detection circuit is operable to detect an increase in an amplitude of the regulated output signal.

15. The power-supply controller of claim 1 wherein the detection circuit is operable to detect a decrease in the amplitude of the regulated output signal.

16. The power-supply controller of claim 1 wherein the detection circuit is operable to detect both an increase and a decrease in the amplitude of the regulated output signal.

17. The power-supply controller of claim 5 wherein the control circuit is operable to compare the regulated output signal to the reference signal and to generate the control signal in response to the comparison.

18. The power-supply controller of claim 4, further comprising:
at least one high-side transistor having a control node coupled to the control circuit and having a drive node operable to be coupled to the at least one power-supply phase; and
at least one low-side transistor having a control node coupled to the control circuit and having a drive node coupled to the drive node of the at least one high-side transistor.

19. The power-supply controller of claim 1, further comprising:
an integrated-circuit die; and
wherein the control circuit and the detection circuit are disposed on the die.

20. The power-supply controller of claim 2, further comprising a generator circuit operable to generate the reference signal.

21. The power-supply controller of claim 4 wherein the control circuit comprises:
a feedback circuit operable to condition the regulated output signal; and
a comparison circuit operable to compare the reference signal to the conditioned regulated output signal and to cause the at least one power-supply phase to generate the regulated output signal in response to the comparison.

22. A power supply, comprising:
an output node operable to provide a regulated output signal;
first and second supply nodes;
at least one power-supply phase; and
a power-supply controller, comprising
a control circuit having a signal characteristic and operable in response to the regulated output signal and a reference signal to alternately allow a phase current to flow through the at least one phase from the first supply node to the output node and from the second supply node to the output node, and
a detection circuit operable to detect a change in the regulated output signal and to alter the signal characteristic of the control circuit in response to the detected change.

23. The power supply of claim 22 wherein the power-supply phase comprises:
a first transistor having a control node coupled to the phase driver, a conduction drive node coupled to the first supply node, and a second conduction node;
a second transistor having a control node coupled to the phase driver, a conduction drive node coupled to the second supply node, and a second conduction node; and
an inductor having a first node coupled to the second conduction nodes of the first and second transistors and having a second node coupled to the output node.

24. The power supply of claim 22, further comprising:
an integrated circuit die; and
wherein the at least one power-supply phase and the power-supply controller are disposed on the die.

25. A system, comprising:
a load; and
a power supply, comprising
an output node operable to provide a regulated output signal to the load,
first and second supply nodes,
at least one power-supply phase, and
a power-supply controller, comprising
a control circuit having a signal characteristic and operable in response to the regulated output signal and a reference signal to alternately allow a phase current to flow through the at least one phase from the first supply node to the output node and from the second supply node to the output node, and
a detection circuit operable to detect a change in the regulated output signal and to alter the signal characteristic of the control circuit in response to the detected change.

26. The system of claim 25 wherein the load comprises an integrated circuit.

27. The system of claim 25 wherein the load and the power supply are disposed on a same integrated-circuit die.

28. The system of claim 25 wherein the load and the power supply are respectively disposed on first and second integrated-circuit dies.

29. A method, comprising:
providing a regulated supply signal to a load with a power supply that includes a control loop having a characteristic; and
changing the characteristic in response to a variation in the load.

30. The method of claim 29, further comprising detecting the variation in the load before changing the characteristic.

31. The method of claim 29 wherein:
the characteristic of the control loop comprises a bandwidth of the control loop; and
changing the characteristic comprises increasing the bandwidth of the control loop.

32. The method of claim 29 wherein:
the characteristic of the control loop comprises a gain of the control loop; and
changing the characteristic comprises increasing the gain of the control loop.

33. The method of claim 29 wherein changing the characteristic of the control loop comprises temporarily changing the characteristic.

34. The method of claim 29 wherein changing the characteristic of the control loop comprises changing the characteristic in response to a magnitude of the variation in the load exceeding a threshold.

35. The method of claim 29 wherein the variation in the load comprises a variation in a magnitude of current being drawn by the load.

36. The method of claim 29, further comprising detecting the variation in the load by detecting a variation in the regulated supply signal.

37. The method of claim 29, further comprising detecting the variation in the load by detecting a variation in a magnitude of the regulated supply signal.

38. A power-supply controller, comprising:
a control circuit having a signal characteristic and operable to generate a regulated first output signal and to generate a second output signal; and
a detection circuit operable to detect a change in one of the first and second output signals and to alter the signal characteristic of the control circuit in response to the detected change.

39. The power-supply controller of claim 38 wherein:
the first output signal comprises a regulated output voltage; and
the second output signal comprises an output current.

40. The power-supply controller of claim 38 wherein the control circuit is operable to cause at least one power-supply phase to generate the regulated first output signal and the second output signal in response to the regulated first output signal and a reference signal.
